(19) United States
(12) Patent Application Publication
(10) Pub. No.: US 2010/0139718 A1
(43) Pub. Date: Jun. 10, 2010

(54) PUMP DEVICE FOR A DISHWASHER, AND ASSOCIATED APPARATUS

(75) Inventor: Jason Duckworth, Kinston, NC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Electrolux Home Products, Inc.

(21) Appl. No.: 12/329,901

(22) Filed: Dec. 8, 2008

(51) Int. Cl. B08B 3/04; F04B 35/04

(52) U.S. Cl. 134/56 D; 417/410.1

(57) ABSTRACT

A pump device for a dishwasher and an associated apparatus are provided. A drain pump assembly and a circulation pump assembly are in fluid communication with the sump assembly, the circulation pump assembly being discretely disposed relative to the drain pump assembly. A pump motor having first and second rotatable output shafts has the first output shaft operably engaged with the drain pump assembly, and the second output shaft operably engaged with the circulation pump assembly. The pump motor selectively and simultaneously drives the first and second output shafts in a first rotational direction to drive the drain pump assembly, without driving the circulation pump assembly, and selectively and simultaneously drives the first and second output shafts in a second rotational direction, opposite to the first rotational direction, to drive the circulation pump assembly, without driving the drain pump assembly, such that the single pump motor drives both pump assemblies.

### BACKGROUND OF THE INVENTION

1. Field of the Invention

Embodiments of the present invention relate to washing appliances and, more particularly, to a pump device for a washing appliance such as a dishwasher, and an apparatus associated therewith.

2. Description of Related Art

Generally, a dishwasher implements a gravity-fed sump for receiving water from the house source, from which the water is circulated by a circulation pump through the spray arms or other water-distribution provisions of the dishwasher for washing the dishware therein. The sump may also be in communication with a separate drain pump for removing the water from the dishwasher. As such, a dishwasher with separate circulation and drain pumps generally requires two separate motors for operating the respective pumps, which undesirably increases the number of components in the dishwasher assembly (with corresponding increased expense), and may result in undesirable space concerns (i.e., the space need to accommodate the two separate motors driving the respective pumps may take away from the dishware capacity of the tub).

Accordingly, there exists a need for an apparatus for reducing the number of components in the dishwasher assembly, while also potentially increasing the dishware capacity of the tub of the dishwasher assembly.

### BRIEF SUMMARY OF THE INVENTION

The above and other needs are met by the present invention which, according to one aspect, provides a pump device for a dishwasher having a tub portion adapted to contain washing fluid for circulation about dishware received therein, and a sump assembly disposed about a lower end of the tub portion for receiving the washing fluid. A controller device selectively controls at least one operational component of the dishwasher. The pump device comprises a drain pump assembly adapted to be in fluid communication with the sump assembly, and to direct washing fluid from the sump assembly away from the tub portion. A circulation pump assembly is adapted to be in fluid communication with the sump assembly and is discretely disposed relative to the drain pump assembly, wherein the circulation pump assembly is further adapted to circulate washing fluid through the tub portion. A pump motor has first and second rotatable output shafts, wherein the first output shaft is operably engaged with the drain pump assembly, and the second output shaft is operably engaged with the circulation pump assembly. The pump motor is configured to selectively and simultaneously drive the first and second output shafts in a first rotational direction to drive the drain pump assembly, without driving the circulation pump assembly. The pump motor is further configured to selectively and simultaneously drive the first and second output shafts in a second rotational direction, opposite to the first rotational direction, to drive the circulation pump assembly, without driving the drain pump assembly. In this manner, the single pump motor is capable of driving both pump assemblies.

Another aspect of the present invention provides a dishwashing appliance, comprising a tub portion configured to contain washing fluid for circulation about dishware received therein, and a sump assembly disposed about a lower end of the tub portion for receiving the washing fluid therein. A drain pump assembly is in fluid communication with the sump assembly, and is configured to direct washing fluid from the sump assembly away from the tub portion. A circulation pump assembly is in fluid communication with the sump assembly and is discretely disposed relative to the drain pump assembly. The circulation pump assembly is further configured to circulate washing fluid through the tub portion. A pump motor has first and second rotatable output shafts, wherein the first output shaft is operably engaged with the drain pump assembly, and the second output shaft is operably engaged with the circulation pump assembly. The pump motor is configured to selectively and simultaneously drive the first and second output shafts in a first rotational direction to drive the drain pump assembly, without driving the circulation pump assembly. The pump motor is further configured to selectively and simultaneously drive the first and second output shafts in a second rotational direction, opposite to the first rotational direction, to drive the circulation pump assembly, without driving the drain pump assembly. In this manner, the single pump motor is capable of driving both pump assemblies.

Embodiments of the present invention thus provide advantages as otherwise detailed herein.

### BRIEF DESCRIPTION OF THE SEVERAL VIEWS OF THE DRAWINGS

Having thus described various embodiments of the invention in general terms, reference will now be made to accompanying drawings, which are not necessarily drawn to scale, and wherein:

FIG. 1 is a perspective view of a dishwasher capable of implementing various embodiments of the present disclosure;

FIG. 2 is a schematic of a dishwashing appliance according to one embodiment of the present disclosure; and

FIG. 3 is a perspective view of a pump device for a dishwashing appliance, according to one embodiment of the present disclosure.

### DETAILED DESCRIPTION OF THE EMBODIMENTS OF THE INVENTION

The present disclosure now will be described more fully hereinafter with reference to the accompanying drawings, in which some, but not all embodiments of the invention are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

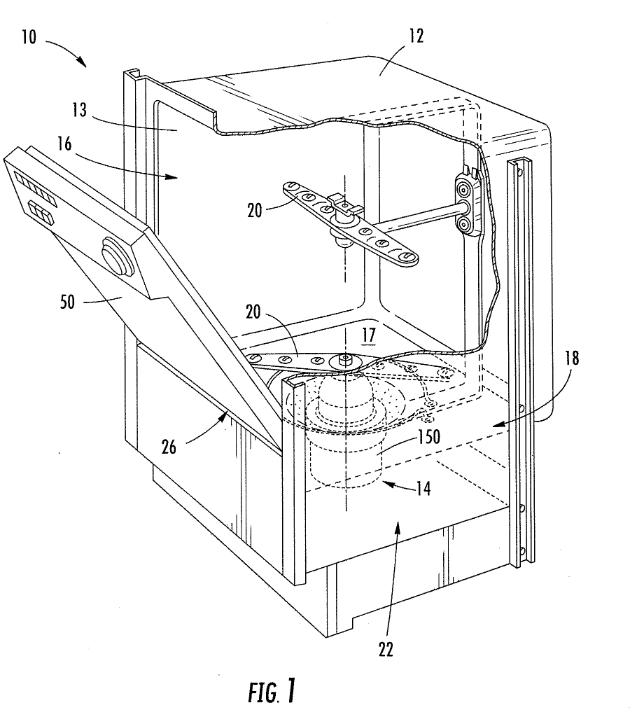

FIG. 1 illustrates one example of a dishwashing appliance, such as a dishwasher 10, capable of implementing various embodiments of the present invention. Such a dishwasher 10 includes a tub portion 12 (partly broken away in FIG. 1 to show internal details) having a plurality of walls (e.g., side wall 13) for forming an enclosure in which dishes, utensils, and other dishware may be placed for washing. The tub portion 12 may also define a forward access opening, generally designated as 16. As known in the art, the dishwasher 10 may also include slidable lower and upper racks (not shown) for holding the dishes, utensils, and dishware to be washed. A door assembly 50 may be pivotably engaged with the tub portion 12 about the lower end 18 thereof so as to selectively permit access to the interior of the tub portion 12. That is, a lower edge 26 of the door assembly 50 may be pivotably engaged (i.e., hinged) with the lower end 18 of the tub portion 12 such that the door assembly 50 is pivotable about the lower edge 26 thereof to provide access to the interior of the tub portion 12 through the forward access opening 16, and to cover and seal the forward access opening 16 when the dishwasher 10 is in operation.

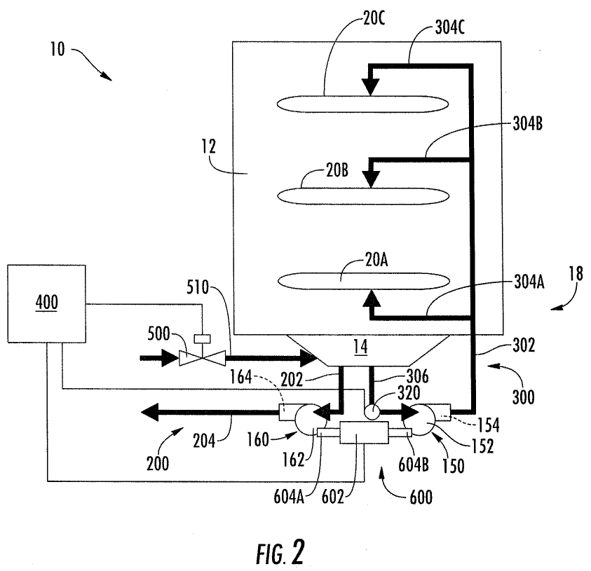

The tub portion 12 may further define or have engaged therewith a sump (or sump assembly), generally designated as 14, in which wash water or rinse water is collected, typically under the influence of gravity. The sump 14 may cooperate with a bottom wall 17 of the tub portion 12 to form the lower end 18 of the tub portion 12, wherein the bottom wall 17 may be sloped to direct washing fluid toward the sump 14. The wash/rinse water may be pumped/recirculated by a circulation pump assembly 150, out of the sump 14 to various spray arms 20 mounted in the interior of the tub portion 12 for spraying the wash/rinse water, under pressure, onto the dishes, utensils, and other dishware contained therein. Further, a drain system may be connected to or otherwise in fluid communication with the sump 14 for removing the dishwashing fluid from the dishwasher 10 via a house drain. In this regard, the drain system may include a drain pump assembly 160 (FIG. 2) configured to pump dishwashing fluid from the sump 14 to the house drain line. The circulation pump assembly 150, drain pump assembly 160, and/or other operational components (e.g., water valve) may be housed, disposed, or otherwise positioned within a base portion/component 22 beneath the tub portion 12, wherein the base portion 22 receives and supports the lower end 18 of the tub portion 12. In some instances, the base portion 22 may be a separate component with respect to the tub portion 12, such as, for example, a molded polymer component, while in other instances, the base portion 22 may be integral with the tub portion 12 such that the side walls forming the tub portion 12 also at least partially form the base portion 22.

As shown in FIG. 2, the hydraulic system of the dishwasher 10 includes a drain system, generally designated 200, incorporated into the lower end 18 of the tub portion 12 of the dishwasher 10. The drain system 200 is configured to remove water (or dishwashing fluid) from the tub portion 12 and into a house drain (sewer) line, after the dishwashing fluid is used to wash dishware disposed within the tub portion 12. Typically, the drain system 200 is positioned below the tub portion 12, in the base portion 22, and includes the drain pump assembly 160 for pumping water out of the sump 14. The drain system 200 may include, for example, the drain pump assembly 160 (FIG. 2), hoses, valves, etc. for effectively removing dishwashing fluid and any food soils/particles carried therein away from the dishwasher 10 toward the house drain line. The drain pump assembly 160 typically includes a drain pump body or housing 162 configured to receive a drain pump impeller 164 therein. The drain pump housing 162 is further configured to receive wash water therein from the sump 14, wherein the drain pump impeller 164 and the drain pump housing 162 cooperate to urge the wash water from the housing 162 (i.e., pump the water from the sump 14 and toward the house drain line).

In some instances, the drain pump assembly 160 or the drain system 200 may include a disposal/chopper/macerator/comminution device (not shown) for reducing the size of the food soils and debris removed from the dishware, and directed therethrough, during the drain cycle. The macerator device may be housed within the drain pump housing 162 (in combination with the drain pump impeller 164), or provided as a separate component from the drain pump assembly 160, but otherwise disposed in or associated with the drain system 200. The drain system 200 may, in some instances, further include an inlet member 202 or hose for transporting water from the sump 14 to the drain pump housing 162 of the drain pump assembly 160, as well as an outlet member 204 or hose operably engaged with the drain pump housing 162 for transporting the water from the drain pump assembly 160 into the house drain line.

With continuing reference to FIG. 2, the dishwashing fluid collected in the sump 14 may be re-circulated by the circulation pump assembly 150 through the spray arm(s) 20 during each of the wash and rinse cycles typically implemented by the dishwasher 10. The circulation pump assembly 150 is disposed in communication with a circulation system 300 of the dishwasher's hydraulic system. The circulation pump assembly 150 typically includes a circulation pump body or housing 152 configured to receive a circulation pump impeller 154 therein. The circulation pump housing 152 is further configured to receive wash water therein from the sump 14, wherein the circulation pump impeller 154 and the circulation pump housing 152 cooperate to urge the wash water from the housing 152 and to the spray arms 20, whereby the dishwashing fluid is circulated throughout the tub portion 12 of the dishwasher 10.

The circulation system 300 of the dishwasher 10 may include a delivery line 302 and associated manifold portions 304A, 304B, 304C for delivering wash water from the circulation pump assembly 150 to the respective spray arms 20A, 20B, 20C. That is, the delivery line 302 is operably engaged with the circulation pump housing 152 for transporting the dishwashing fluid to the spray arms 20A, 20B, and 20C. The circulation system 300 may further include an inlet line 306 or hose for transporting water from the sump 14 to the circulation pump housing 152 of the drain pump assembly 150.

In some instances, a control device 400 of the dishwasher 10 may be in communication with one or more sensors or monitoring devices such as, for example, a turbidity sensor (see, e.g., element 320), which measures the amount of particulate suspended in the wash water within the dishwasher 10 as the wash water circulates through the circulation system 300/hydraulic system thereof and through the spray arms 20A, 20B, 20C for spraying the wash water onto the dishware. In some instances, a single turbidity sensor 320 is disposed within the circulation system 300 prior to or otherwise in association with the feed of the wash water into the circulation pump 150 (i.e., in or about the sump 14). A water inlet valve 500 associated with a water supply line 510 may be provided for selectively supplying clean outside water to the dishwasher 10, during a washing cycle. In this regard, the water inlet valve 500 may be in communication with the control device 400, such that the control device 400 can control actuation of the water inlet valve 500. The control device 400 may be further configured to direct or otherwise execute an appropriate action such as, for example, actuating the drain pump assembly 160 and/or the circulation pump assembly 150.

As previously mentioned, the drain pump assembly 160 and the circulation pump assembly 150, in the prior art, may be driven by separate motors or actuators engaged therewith. In this regard, the two separate motors for operating the respective pump assemblies may undesirably increase the number of components in the dishwasher assembly (with corresponding increased expense), and may result in undesirable space concerns (i.e., the space need to accommodate the two separate motors driving the respective pump assemblies may take away from the dishware capacity of the tub portion 12).

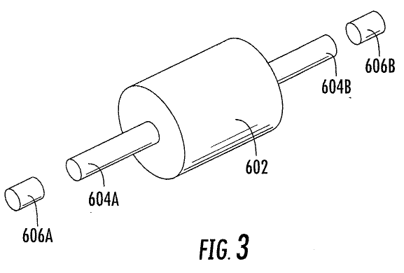

In accordance with embodiments of the present disclosure, with reference to FIGS. 2 and 3, the dishwasher 10 may thus include a pump device 600 having a single pump motor 602 for operating both the circulation and drain pump assemblies 150, 160. In this regard, such a dishwasher 10 may include separate circulation and drain pump assemblies 150, 160, wherein these respective circulation and drain pump assemblies 150, 160 are plumbed into the hydraulic system of the dishwasher 10 for providing the normal or otherwise desired circulation and drainage functions. The pump motor 602 may be, for example, an electric motor, operably engaged with the pump impellers 154, 164 disposed within the respective pump housing 152, 162 for driving the pump impellers 154, 164. That is, the pump motor 602 may be operably engaged with the drain pump impeller 164 disposed within the drain pump housing 162 so as to cooperate therewith to move the water out of the sump 14 and into the house drain line (i.e., so as to remove the water from the dishwasher 10), and further operably engaged with the circulation pump impeller 154 disposed within the circulation pump housing 152 so as to cooperate therewith to move the water through the circulation system 300. The pump motor 602 may also be in electrical communication with the control device 400, wherein the control device 400 may be configured so as to be capable of selectively actuating the pump motor 602 to provide the desired circulation or drain function.

In some embodiments, the circulation and drain pump assemblies 150, 160 may be operably engaged with a single, reversible pump motor 602 having first and second rotatable output shafts 604A, 604B. The first and second output shafts 604A, 604B may, in some instances, comprise shaft ends of a single shaft member extending through the pump motor 602 (i.e., so as to essentially comprise “opposing” output shafts). In such instances, rotation of the single shaft member will cause both shaft ends to rotate in the same direction. In order to operate the circulation and drain pump assemblies 150, 160 at the appropriate instances (generally one of the circulation and drain pump assemblies 150, 160 is not operated at the same time as the other of the circulation and drain pump assemblies 150, 160), certain embodiments implement the rotation of the output shafts in one rotational direction (the “first rotational direction”) to drive one of the circulation and drain pump assemblies 150, 160 (i.e., the drain pump assembly 160), and rotation of the output shafts in the other rotational direction (the “second rotational direction” opposite to the first rotational direction) to drive the other of the circulation and drain pump assemblies 150, 160 (i.e., the circulation pump assembly 150).

As such, in order for one of the circulation and drain pump assemblies 150, 160 to remain inactive as the other of the circulation and drain pump assemblies 150, 160 is driven by the pump motor 602, certain aspects of the present invention may implement first and second clutch mechanisms 606A, 606B operably engaged between each of the output shafts 604A, 604B and the respective circulation and drain pump assemblies 150, 160. For example, the first clutch mechanism 606A may be operably engaged between the drain pump assembly 160 and the first output shaft 604A so as to couple the two components. Further, the second clutch mechanism 606B may be operably engaged between the circulation pump assembly 150 and the second output shaft 604B so as to couple the two components.

The clutch mechanisms 606A, 606B, as will be appreciated by one skilled in the art, may be generally configured to have two portions having a disengaged condition and an engaged condition therebetween. In such instances, one portion may be engaged with one of the impellers, while the other portion may be engaged with the corresponding output shaft from the motor 602. As such, if the clutch mechanism is in the disengaged condition, rotational motion and/or torque will not be transmitted from the output shaft to the impeller. However, if the engaged condition is met, the rotational motion and/or torque will be transmitted from the output shaft to the impeller. In one exemplary instance, each clutch mechanism 606A, 606B may be configured to provide an engaged condition when the corresponding output shaft rotates in one direction, and a disengaged condition when the corresponding output shaft rotates in the other (opposite direction).

As such, in some aspects of the present invention, when the pump motor 602 is actuated to turn the output shafts 604A, 604B in the first direction (i.e., a clockwise direction), one of the first and second clutch mechanisms 606A, 606B (i.e., the first clutch mechanism 606A associated with the drain pump assembly 160) may be configured to “lock up” or otherwise form an engaged condition. Accordingly, the drain pump assembly 160 engaged therewith would become operational (i.e., pump the wash water from the sump 14 to the house drain). However, in light of the output shafts 604A, 604B rotating in the first direction, the second clutch mechanism 606B associated with the circulation pump assembly 150 may be configured not to “lock up” or enter an engaged position. As such, operation of the drain pump assembly 160 can be achieved without operation of the circulation pump assembly 150.

Further, in light of the reversible rotation pump motor 602 implemented by various aspects of the present invention, the opposite condition may be realized when the rotational direction of the pump motor 602 is reversed. That is, when the pump motor 602 is actuated to turn the output shafts 604A, 604B in the second direction (i.e., a counterclockwise direction) opposite to the first direction, the other of the first and second clutch mechanisms 606A, 606B (i.e., the second clutch mechanism 606B associated with the circulation pump assembly 150) may be configured to “lock up” or otherwise form an engaged condition. Accordingly, the circulation pump assembly 150 engaged therewith would become operational (i.e., pump the wash water from the sump 14 through the spray arms 20A, 20B, 20C). However, in light of the output shafts 604A, 604B rotating in the second direction, the first clutch mechanism 606A associated with the drain pump assembly 160 may be configured not to “lock up” or enter an engaged position. As such, operation of the circulation pump assembly 150 can be achieved without operation of the drain pump assembly 160, by reversing the rotational direction of the single pump motor 602 (i.e., via the control device 400) intermediately engaged between the circulation and drain pump assemblies 150, 160.

That is, for example, the pump motor 602 may be actuated by the control device 400 to rotate the output shafts 604A, 604B in the clockwise direction to operate the circulation pump assembly 150, while not operating the drain pump assembly 160, wherein the control device 400 may then reverse the rotational direction of the pump motor 602 to rotate the output shafts 604A, 604B in the counterclockwise direction to operate the drain pump assembly 160, while not operating the circulation pump assembly 150. In this manner, each of the circulation and drain pump assemblies 150, 160 may be independently operated by the single pump motor 602.

Of course, one of skill in the art will recognize that the rotational direction of the output shafts 604A, 604B could be switched such that, for example, clockwise rotation thereof causes the drain pump assembly 160 to operate and counterclockwise rotation thereof causes the circulation pump assembly 150 to operate. Furthermore, one of skill in the art will recognize that the output shafts 604A, 604B may be operably engaged with the respective pump assembly 150, 160 by coupling mechanisms other than the clutch mechanisms 606A, 606B, provided that rotation of the output shafts 604A, 604B in a first direction only operates one of the pump assemblies 150, 160, and rotation in the opposite direction only operates the other of the pump assemblies 150, 160.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for the purposes of limitation.

That which is claimed:

1. A pump device for a dishwasher having a tub portion adapted to contain washing fluid for circulation about dishware received therein, the dishwasher having a sump assembly disposed about a lower end of the tub portion for receiving the washing fluid, and a controller device for selectively controlling at least one operational component of the dishwasher, the pump device comprising:
a drain pump assembly adapted to be in fluid communication with the sump assembly, and to direct washing fluid from the sump assembly away from the tub portion;
a circulation pump assembly adapted to be in fluid communication with the sump assembly and being discretely disposed relative to the drain pump assembly, the circulation pump assembly being further adapted to circulate washing fluid through the tub portion; and
a pump motor having first and second rotatable output shafts, the first output shaft being operably engaged with the drain pump assembly, and the second output shaft being operably engaged with the circulation pump assembly, the pump motor being configured to selectively and simultaneously drive the first and second output shafts in a first rotational direction to drive the drain pump assembly, without driving the circulation pump assembly, the pump motor being further configured to selectively and simultaneously drive the first and second output shafts in a second rotational direction, opposite to the first rotational direction, to drive the circulation pump assembly, without driving the drain pump assembly, such that the single pump motor is capable of driving both pump assemblies.

2. A pump device according to claim 1 further comprising a first clutch mechanism operably engaged between the first output shaft and the drain pump assembly, and a second clutch mechanism operably engaged between the second output shaft and the circulation pump assembly, the first clutch mechanism being configured to engage in response to the first and second output shafts being simultaneously driven in the first rotational direction to drive the drain pump assembly, without driving the circulation pump assembly, and the second clutch mechanism being configured to engage in response to the first and second output shafts being simultaneously driven in the second rotational direction to drive the circulation pump assembly is driven, without driving the drain pump assembly.

3. A pump device according to claim 1 wherein the drain pump assembly comprises a drain pump housing configured to receive a drain pump impeller mechanism therein, the drain pump impeller mechanism being operably engaged with the first output shaft, and the circulation pump assembly comprises a circulation pump housing configured to receive a circulation pump impeller therein, the circulation pump impeller mechanism being operably engaged with the second output shaft, each of the drain and circulation pump assemblies being configured to receive dishwashing fluid into the respective housing, wherein the washing fluid is subsequently urged from the respective housing through cooperation between the corresponding impeller mechanism and housing.

4. A pump device according to claim 1, further comprising a controller device in communication with the pump motor and configured to selectively control operation of the drain pump assembly and the circulation pump assembly.

5. A dishwashing appliance, comprising:
a tub portion configured to contain washing fluid for circulation about dishware received therein;
a sump assembly disposed about a lower end of the tub portion for receiving the washing fluid therein;
a drain pump assembly in fluid communication with the sump assembly, and configured to direct washing fluid from the sump assembly away from the tub portion;
a circulation pump assembly in fluid communication with the sump assembly and discretely disposed relative to the drain pump assembly, the circulation pump assembly being further configured to circulate washing fluid through the tub portion; and
a pump motor having first and second rotatable output shafts, the first output shaft being operably engaged with the drain pump assembly, and the second output shaft being operably engaged with the circulation pump assembly, the pump motor being configured to selectively and simultaneously drive the first and second output shafts in a first rotational direction to drive the drain pump assembly, without driving the circulation pump assembly, the pump motor being further configured to selectively and simultaneously drive the first and second output shafts in a second rotational direction, opposite to the first rotational direction, to drive the circulation pump assembly, without driving the drain pump assembly, such that the single pump motor is capable of driving both pump assemblies.

6. A dishwashing appliance according to claim 5 further comprising a first clutch mechanism operably engaged between the first output shaft and the drain pump assembly, and a second clutch mechanism operably engaged between the second output shaft and the circulation pump assembly, the first clutch mechanism being configured to engage in response to the first and second output shafts being simultaneously driven in the first rotational direction to drive the drain pump assembly, without driving the circulation pump assembly, and the second clutch mechanism being configured to engage in response to the first and second output shafts being simultaneously driven in the second rotational direction to drive the circulation pump assembly is driven, without driving the drain pump assembly.

7. A dishwashing appliance according to claim 5 wherein the drain pump assembly comprises a drain pump housing configured to receive a drain pump impeller mechanism therein, the drain pump impeller mechanism being operably engaged with the first output shaft, and the circulation pump assembly comprises a circulation pump housing configured to receive a circulation pump impeller therein, the circulation pump impeller mechanism being operably engaged with the second output shaft, each of the drain and circulation pump assemblies being configured to receive dishwashing fluid into the respective housing, wherein the washing fluid is subsequently urged from the respective housing through cooperation between the corresponding impeller mechanism and housing.

8. A dishwashing appliance according to claim 5 further comprising a controller device in communication with the pump motor and configured to selectively control operation of the drain pump assembly and the circulation pump assembly.
